(19) United States
(12) Patent Application Publication
(10) Pub. No.: US 2010/0255865 A1
(43) Pub. Date: Oct. 7, 2010

(54) TEXT MESSAGE INCLUDING A CONTEXTUAL ATTRIBUTE OF A MOBILE DEVICE

(76) Inventor: Amit Karmarkar, Palo Alto, CA (US)

Correspondence Address: RICHARD R. PETERS, 26512 AVENIDA VERONICA, MISSION VIEJO, CA, 92691, US

(21) Appl. No.: 12/819,147

(22) Filed: Jun. 18, 2010

Related U.S. Application Data
(63) Continuation-in-part of application No. 12/422,313, filed on Apr. 13, 2009.
Application No. 12/422,313 is a continuation-in-part of application No. 11/519,200, filed on Sep. 12, 2006.
Application No. 11/519,200 is a continuation-in-part of application No. 11/231,575, filed on Sep. 21, 2005, now Pat. No. 7,580,719.
(60) Provisional application No. 61/161,763, filed on Mar. 19, 2009.

(51) Int. Cl. H04W 4/14

(52) U.S. Cl. 455/466

(57) ABSTRACT

Disclosed are a system, method, and article of manufacture of a text message including a contextual attribute of a mobile device. A context-enriched text message is prepared by a process that includes the step of providing a text-message component generated with a mobile device. A context data including information about a contextual attribute of the mobile device is provided. The text-message component and the context data are associated. The context data may be relevant to a meaning of the text-message component.

### CLAIM OF PRIORITY

This application is a continuation-in-part of and claims priority to patent application Ser. No. 12/422,313 filed on Apr. 13, 2009 which claims priority from provisional application 61/161,763 filed on Mar. 19, 2009. patent application Ser. No.12/422,313 is a continuation-in-part of patent application Ser. No. 11/519,200 filed Sep. 11, 2006, issued as U.S. Pat. No. 7,551,935. patent application Ser. No. 11/519,200 is a continuation-in-part of patent application Ser. No. 11/231,575 filed Sep. 21, 2005, issued as U.S. Pat. No. 7,580,719. U.S. Pat. Nos. 7,551,935 and 7,580,719 are herein incorporated by reference.

### FIELD OF TECHNOLOGY

This disclosure relates generally to mobile device communication and more particularly to a text messaging service.

### BACKGROUND

A mobile phone may include a text messaging application. A sending user may use the text messaging application to compose and send a text message. The text message may generically refer to a context of the mobile phone such as its location. For example, the text message may include the term “here”. A receiving user may not be able to understand the meaning of the term without more contextual information that further describes the term. The text-messaging application may also have functional limitations that discourage more detailed descriptions. For example, a text message may be limited to certain number of octets of data. Consequently, the meaning of some terms in the text message may be vague. Inability to understand the intended meaning of a term may diminish the effectiveness of the text-messaging mode of communication.

### SUMMARY

A system, method, and article of manufacture of a text message including a contextual attribute of a mobile device are disclosed.

In one aspect, a method includes generating a context-enriched message including the message component and the context data. The method uses the results of the steps of providing a text message generated by a mobile device; identifying a message component of the text message; determining a contextual attribute of the mobile device; and deriving a context data from the contextual attribute.

The method may include communicating the context-enriched message to a segment of a cellular network. The contextual attribute of the mobile device can include a geolocation of the mobile device. The text message may be a multimedia message service (MMS) message. The text message may be a short messaging service (SMS) message.

In another aspect, a context-enriched text message is prepared by a process that includes the step of providing a text-message component generated with a mobile device. A context data is provided. The context data includes information about a contextual attribute of the mobile device. The text-message component and the context data are associated. The context data may be relevant to a meaning of the text-message component.

In yet another aspect, a computer-implemented method includes providing a short message from a first mobile device. The short message is processed through at least one server. The processing includes parsing the short message, generating the short message's context data, and associating the context data with the short message. The short message and the context data are encoded into a format transmittable through a communication network. The communication network may be a cellular network. The communication network may be an IP network. The server can include a cultural database that includes a database of prior short messages

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying Drawings and from the Detailed Description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a system view of a messaging service, according to some embodiments.

FIG. 1B illustrates an example implementation of interworking a GPRS cellular network with an IP-base network entity, according to some embodiments.

FIG. 2 shows a simplified block diagram of a mobile device, in accordance with some embodiments.

FIG. 3 shows a block diagram of a computer operable to execute the disclosed architecture of a communications server, according to some embodiments.

FIG. 4 illustrates a block diagram of an exemplary client-server computing environment, in accordance with some embodiments.

FIG. 5A illustrates an implementation of a client-server communication paradigm with an SMPP protocol, according to some embodiments.

FIG. 5B illustrates a format of a context-enriched message, according to some embodiments.

FIG. 6 illustrates an example of a context-enriched message presented on a display screen of a mobile device, according to some embodiments.

FIG. 7 is a flowchart illustrating the generation of a context-enriched message, according some embodiments.

Other features of the present embodiments will be apparent from the accompanying Drawings and from the Detailed Description that follows.

### DETAILED DESCRIPTION

A system, method, and article of manufacture of a text message including a contextual attribute of a mobile device are disclosed. Although the embodiments have been described with reference to specific example embodiments, it will be evident that various modifications and changes may be made to these embodiments without departing from the broader spirit and scope of the various embodiments.

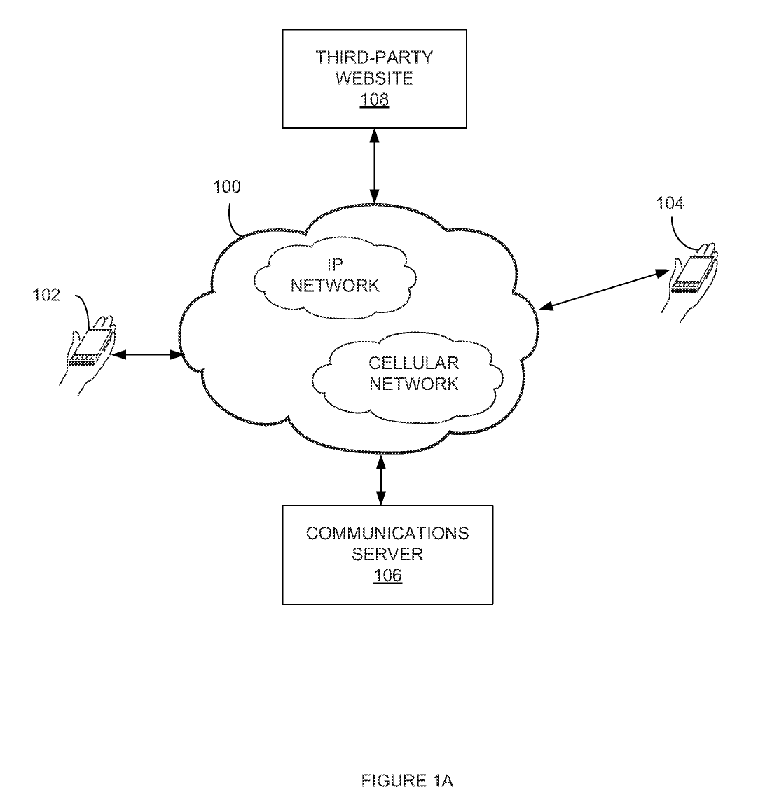

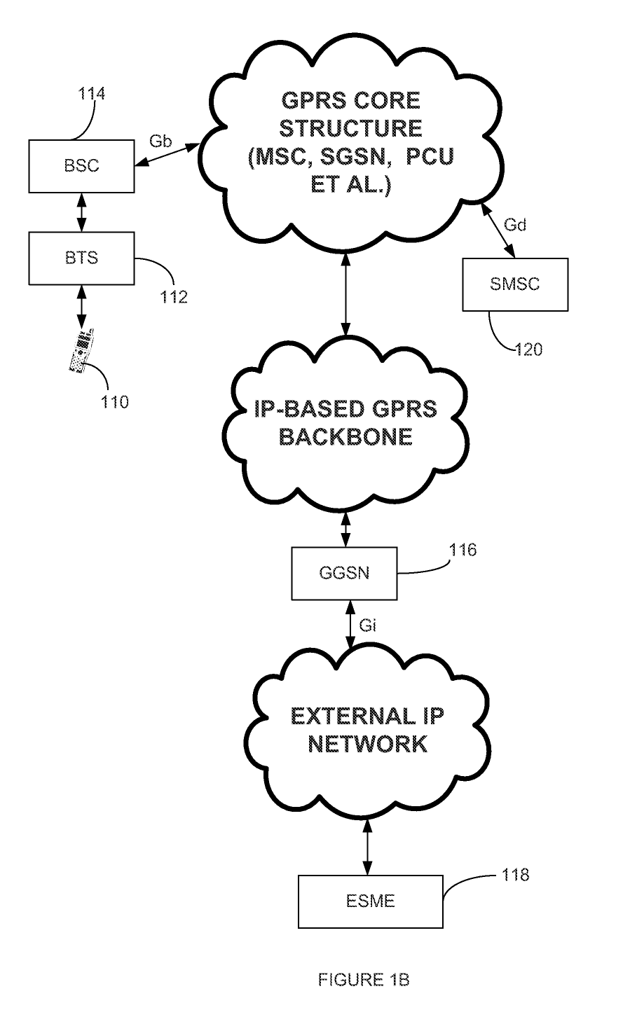

FIG. 1A is a system view of a messaging service, according to some embodiments. Communication network(s) 100 can include any suitable circuitry, device, system or combination of these (e.g., a wireless communications infrastructure including communications towers and telecommunications servers, an IP network, and the like) operative to create communications network 100. Communication network 100 can provide wireless communications using any suitable short-range or long-range communications protocol. In some embodiments, communication network 100 can support Wi-Fi (e.g., an 802.11 protocol), Bluetooth™, high frequency systems (e.g., 900 MHz, 2.4 30 GHz, and 5.6 GHz communication systems), infrared, other relatively localized wireless communication protocols, or any combination thereof.

In some embodiments, communication network 100 can support protocols used by wireless and cellular phones and personal email devices. Such protocols can include, for example, GSM, GSM plus EDGE, CDMA, UMTS, quadband, and other cellular protocols. In another example, a long-range communications protocol can include protocols for placing or receiving calls using Voice Over Inter Protocol (VOIP). Furthermore, in some embodiments, communication network 100 can include an internet-protocol (IP) based network such as the Internet. Communication network 100 operatively couples the various computer systems of FIG. 1A, such as the mobile devices 102 and 104, the communications server 106 and the third-party server 108, as well as other servers and devices (e.g. MSC, SMSC, gateways and the like) not shown for purposes of clarity.

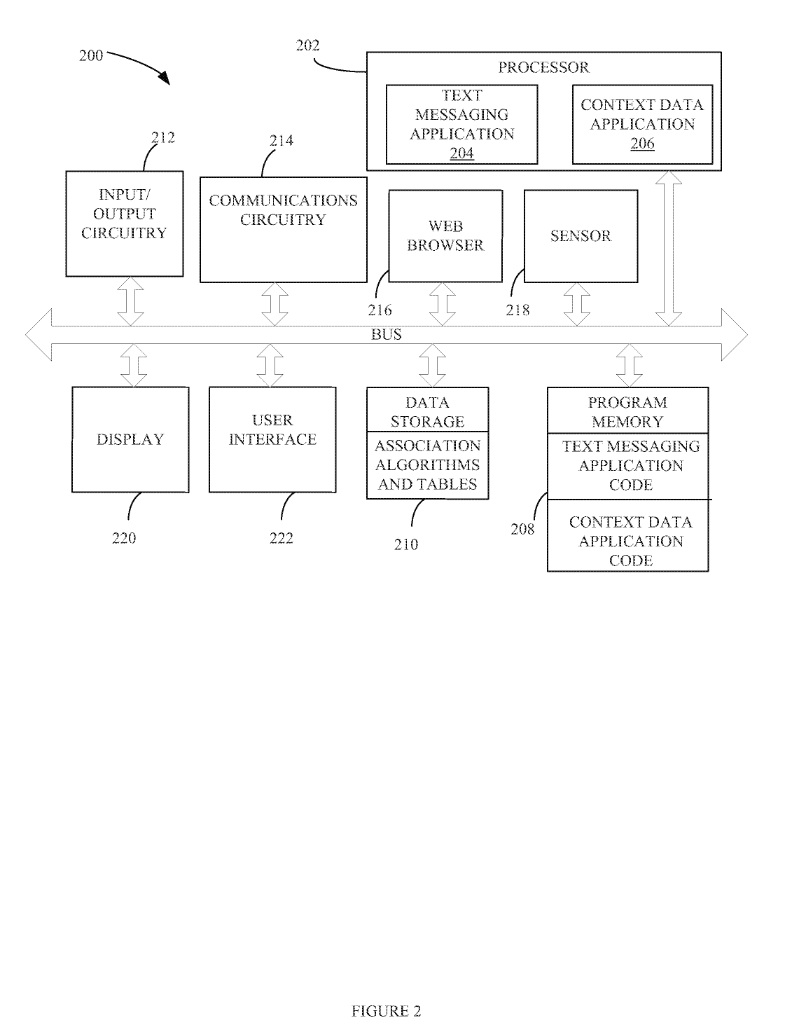

Mobile devices 102 and 104 can include mobile computing devices (e.g. a smart phone such as the iPhone®, Motorola Droid®, Blackberry®, or Nexus One®) such as the one described in conjunction with FIG. 2 infra. Mobile devices 102 and 104 can include smart phone capabilities such as a web browser, an SMS application, an MMS application, a EMS application, other types of text messaging applications (e.g. IMS), cellular telephony, an internet telephony application (e.g. VoIP), and the like.

In some embodiments, mobile devices 102 and 104 can also include an application for transmitting and receiving files that include context data to communications server 106 and/or third-party server 108. Mobile devices 102 and 104 include context data acquisition and analysis capabilities.

In some embodiments, mobile devices 102 and 104 can communications server 106 to scale the processing and data storage capabilities. Thus, communications server 106 can include the same functionalities and applications as describe supra with regards to mobile devices 102 and 104. Moreover, communications server 106 can include additional circuits and/or software functionalities configured to include context-enhancement data in a text message. Context-enhancement data can be used to enhance the presentation of a text message and/or context data (e.g. with additional graphics, mashups, additional data and the like). In some embodiments, context-enhancement data can be obtained from third-party server 108.

In some embodiments, communications server 106 can interface with a component of a cellular network (e.g. as a value-added service provider (VASP)). Likewise, in some embodiments, communications server 106 can reside on a message center of a cellular network. In this way, communications server 106 can configure an incoming context-enriched message into a format compatible with a particular cellular network and/or text message protocol. In some embodiments, communications server 106 can store portions of a context-enriched message for later access by a receiving mobile device while delivering other portions of the context-enriched message. For example, communications server 106 can store the context data portion of the context-enriched message while forwarding the text portion and a hyperlink. The hyperlink can provide the location of the context-data on a document hosted by communications server 106.

FIG. 1B illustrates an example implementation of interworking a GPRS cellular network with an IP-base network, according to some embodiments. Typically, a GPRS network uses several common elements of an existing GSM network such as a mobile switching center (MSC) (not shown for purposes of clarity). MSC can be a telecommunication switch or exchange within a cellular network architecture capable of interworking with location databases. The GPRS network adds several additional new network elements, interfaces and data-packet handling protocols not typically found in a GSM system. For example, GPRS can be enabled on a GSM network with the addition of two modules, a Serving GPRS Service Node (“SGSN”) (not shown) and a Gateway GPRS Service Node (“GGSN”) 116. GGSN 116 can serve as a gateway between the GPRS network and an external IP network such as an Internet, an x.25 network, or another GPRS network (e.g. to facilitate GPRS roaming). GGSN 116 can be communicatively coupled with an external IP network (e.g. via interface Gi). GGSN 116 can also be communicatively coupled with a SGSN via an IP-based GPRS backbone network. A SGSN can be viewed as a “packet-switched MSC”. Additionally, a SGSN provides packet routings to and from its service area for mobile stations in that service area. SGSN can also detect new GPRS mobile stations in a given service area, process registration of new mobile stations, and maintain a record of their respective locations inside the given area.

In the context of a GPRS system, mobile station 110 can be a device used by a mobile subscriber, such as mobile devices 102 and 014, which is GPRS-attached and can handle an air interface in GPRS network. Mobile station 110 can packetize traffic directly. In some embodiments, mobile station 110 can support high-speed data access. Mobile station 110 profiles are stored in home location registers (“HLR”) that are accessible by SGSN via a local MSC. A logical link can be established and maintained between a mobile station and a specific SGSN in each mobile network. At the end of transmission or when the mobile station moves out of the area of a specific SGSN, the logical link and the associated resources can be reallocated. SGSN can also be communicatively coupled to a BSC (Base Station Controller) 114 via a frame relay connection. BSC 114 manages radio resources including Base Transceiver Station (“BTS”) 112. BTS 112 can be a physical system, such as a radio tower, that is used to transmit radio frequencies over an air interface. The BSC 114 can be communicatively coupled with several BTSs. Each BTS may serve more than one mobile station. The BSC 114 and BTS 112, as a whole, are generally referred to as a BSS (Base Station System). To be utilized in the GPRS network, BSC 114 can be linked to a Packet Control Unit (“PCU”) (not shown) that provides a physical and logical data interface out of the BSS for packet data traffic. PCU can convert packet data to/from SGSN into a format that can be transferred to External Short Messaging Entity (ESME) 118 and/or another mobile station. Furthermore, PCU can implement quality of service (QoS) measurements.

For example, when either voice or data traffic is originated at the mobile station 110, it is transported over the air interface to BTS 112, and from BTS 112 to BSC 114 in the same way as in a standard GSM message. However, at the output of BSC 114, the traffic is separated. Circuit-switched voice is sent to MSC via circuit-switched channels per standard GSM, and data is sent to SGSN via PCU over the Frame Relay Interface (e.g. through interface Gb) and packet-switched signaling channels (through interface Gs—not shown).

In some embodiments, External Short Messaging Entity (ESME) 118 can reside on a server (e.g. communications server 106) communicatively coupled with IP network. In some embodiments, ESME 118 can reside in a mobile device 200 as a context-data application (e.g. context-data application 206). In some embodiments, ESME 118 can submit and receive context-enriched text messages to and from the SMSC 120 (or in some embodiments, an MMSC) using a TCP/IP protocol, such as the Short Message Peer-to-Peer Protocol (SMPP), Universal Computer Protocol (UCP), OIS, Computer Interface to Message Distribution (CIMD), SMCI, an External Machine Interface (EMI), or a similar proprietary protocol. The SMSC 120 can then deliver the data packets to the mobile station 110. Additionally, in some embodiments, interworking between an SS7 (Signaling System No. 7) system such as the SMSC 120 and IP-based network 118 can be achieved by the use of a signaling gateway (not shown). In some embodiments, ESME 118 can transfer data packets that include a context-enriched message to a mobile station application via the SGSN and bypass the SMSC (e.g. using a client-server model).

FIG. 2 shows a simplified block diagram of a mobile device 200 in accordance with some embodiments. Mobile device 200 can be a portable computing device dedicated to processing multi-media data files and presenting that processed data to the user. For example, in some embodiments, mobile device 200 can be a dedicated media player (e.g., MP3 player), a game player, a remote controller, a portable communication device, a PDA (Packet Data Access) device with an embedded GSM telephone, a PC card for a laptop computer, a remote ordering interface, a tablet computer or other suitable personal device. In some embodiments, mobile device 200 can be a portable device dedicated to providing multi-media processing and telephone functionality in single integrated unit (e.g. a smart phone).

Mobile device 200 can be battery-operated and highly portable to allow a user to listen to music, play games or videos, record video or take pictures, place and take telephone calls, communicate with other people or devices, control other devices, and any combination thereof. In addition, mobile device 200 can be sized such that it fits relatively easily into a pocket or hand of the user. By being handheld, mobile device 200 is relatively small and easily handled and utilized by its user and thus can be taken practically anywhere the user travels.

Mobile device 200 can include processor 202, text messaging application 204, context-data application 206, program memory 208, data storage 210, input/output circuitry 212, communications circuitry 214, web browser 216, sensor 218, display 220, and/or user interface 222. In some embodiments, mobile device 200 can include more than one of each component or circuitry but for the sake of clarity and illustration, only one of each is shown. In addition, it will be appreciated that the functionality of certain components and circuitry can be combined or omitted and that additional components and circuitry, which are not shown in FIG. 2, can be included in mobile device 200.

Processor 202 can include, for example, circuitry for and be configured to perform any function. Processor 202 can be used to run operating system applications, media playback applications, media editing applications, and/or any other application. Processor 202 can drive display 220 and can receive user inputs from user interface 222.

FIG. 2 shows text messaging application 204 and context-data application 206 loaded into processor 202 to perform their respective functions. Text message application 204 provides applications for the composing, sending and receiving of text messages. Text messaging application 204 can include an SMS, MMS, EMS and/or other text messaging application configured to exchange text between mobile devices 102 and 104 over communications network 100. In some embodiments, ext messaging application 204 can include image, video, and sound content in a text message (e.g. in an MMS message).

Context-data application 206 can parse and analyze a text message. Context-data application 206 can determine a meaning of a particular term or portion of the text message using association algorithms and/or databases. In some embodiments, association algorithms and/or databases can be stored in data storage 210. Context-data application 206 can utilize then acquire the relevant context data. Context data can be acquired on a periodic basis and stored in data storage 210. Context-data application 206 can provide a register of stored context-data and metadata about the context-data (e.g. time stamp data, location of acquisition and the like). Context data can also be acquired on an as-needed basis with sensor 218. Context-data application 206 then generates a text message that includes the term or phrase and the context data.

In some embodiments, context-data application 206 can utilize one or more text analytic techniques to turn text into data for analysis via application of natural language processing (NLP) and other analytical methods. Text analytics can involve information retrieval, lexical analysis to study word frequency distributions, pattern recognition, tagging/annotation, information extraction, data mining techniques including link and association analysis, visualization, and predictive analytics.

In some embodiments, context-data application 206 can utilize one or more pattern recognition algorithms to determine the meaning of a word and/or phrase. Suitable types of pattern recognition algorithms can include neural networks, support vector machines, decision trees, K-nearest neighbor, Bayesian networks, Monte Carlo methods, bootstrapping methods, boosting methods, or any combination thereof.

In one example, a text message can include the term “here”. The context-data application can determine that the meaning of the term “here” is related to the present location of the mobile device. Context-data application 206 can then query the operating system of the mobile device to acquire the mobile device's present GPS coordinates. In another example, a table can match a term with a sensor 218. Context data can be derived from the sensor data. Context-data application 206 can then associate with the term in the text message (e.g. with hypertext, provide a hyperlink to a mashup such as a third-party mapping service and/or an explicit association such as textually or graphically providing a description of the context data).

In some embodiments, context-data application 206 can time stamp acquired context data. Additionally, context data application 206 can also encode and format context data for communication according to a protocol utilized by the communications network 100. Furthermore, context data application 206 can receive context data inquiries from and provide the context data to a remote application (e.g. such as a context-data puller 320 and/or an SMSC application). Context-data application 206 can communicate the context-enriched text message (a text message that includes context data) to an entity of a cellular network such as a message center. For example, in some embodiments, context-data application 206 can use an SMPP protocol to communicate a context-enriched message to SMSC 120. SMSC 120 can then store and forward the context-enriched message to another mobile device.

Data storage 210 can include one or more storage mediums, such as, a hard-drive, flash memory, permanent memory such as ROM, semipermanent memory such as RAM, any other suitable type of storage component, or any combination thereof. Data storage 210 can store media data (e.g., music and video files), application data (e.g., for implementing functions on mobile devices 102 and 104), firmware, preference information data (e.g., media playback preferences), lifestyle information data (e.g., food preferences), exercise information data (e.g., information obtained by exercise monitoring equipment), transaction information data (e.g., information such as credit card information), wireless connection information data (e.g., information that can enable the mobile devices 102 and 104 to establish a wireless connection), subscription information data (e.g., information that keeps track of podcasts or television shows or other media a user subscribes to), contact information data (e.g., telephone numbers and email addresses), calendar information data, any other suitable data, or any combination thereof.

User interface 222 can allow a user to interact with mobile device 200. For example, the device for user interface 222 can take a variety of forms, such as at least one a button, keypad, dial, a click wheel, a touch screen or any combination thereof.

Display 220 can accept and/or generate signals for presenting media information (textual and/or graphic) on a display screen, such as those discussed above. For example, display 220 can include a coder/decoder (CODEC) to convert digital media data into analog signals. Display 220 also can include display driver circuitry and/or circuitry for driving display driver. Processor 202 and display 220 can generate the display signals. The display signals can provide media information related to data received from communications circuitry 214 and/or any other component of mobile device 200.

Program memory 208 can include one or more different types of memory for performing device functions. For example, program memory 208 can include cache, Flash, ROM, RAM, or one or more different types of memory used for temporarily storing data. Program memory 208 can also be store firmware. For example, program memory 208 can be provided for storing firmware for device applications (e.g., operating system, user interface functions, and processor functions). FIG. 2 illustrates program memory storing the code for the text messaging application 204 and the context-data application 206. It should be noted that in some embodiments, the code can be implemented as discreet code modules. However, in some embodiments, the code can be organized in other formats that still implemented the represented functionality.

Input/output circuitry 212 can format data, analog signals and other signals (e.g., physical contact inputs, physical movements, analog audio signals, etc.) into digital data, and vice-versa. The digital data can be provided to and received from processor 202, data storage 210, and program memory 208, or any other component of mobile device 200. Although input/output circuitry 212 is illustrated in FIG. 2 as a single component of mobile device 200, a plurality of input/output circuitry can be included in mobile device 200. Input/output circuitry 212 can be used to interface with any input or output component. For example, mobile device 200 can include specialized input circuitry associated with input devices such as, for example, one or more microphones, cameras, proximity sensors, accelerometers, ambient light detectors, magnetic card readers, and the like. Mobile device 200 can also include specialized output circuitry associated with output devices such as one or more audio speakers, and the like.

Communications circuitry 214 can permit mobile device 200 to communicate with one or more servers or other devices using any suitable communications protocol. For example, communications circuitry 214 can support Wi-Fi (e.g., a 802.11 protocol), Ethernet, Bluetooth™ (which is a trademark owned by Bluetooth Sig, Inc.) high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. The mobile device 200 can include a sensor. Additionally, the mobile device 200 includes a client program, such as web browser 216, for retrieving, presenting, and traversing information resources on the World Wide Web.

The mobile device 200 further includes at least one sensor 218. In some embodiments, the sensor 218 can be a device that measures, detects or senses an attribute of the mobile device's environment and then converts the attribute into a machine-readable form that can be utilized by an application such as the context data manager 206. In some embodiments, a sensor 218 can be a device that measures an attribute of a physical quantity and converts the attribute into a user-readable or computer-processable signal. In certain embodiments, a ‘virtualized’ sensor 218 can also measure an attribute of a data environment and a computer environment (e.g. in a computer game or virtual world) in addition to a physical environment. Example sensors include, inter alia, global positioning system systems, accelerometers, inclinometers, position sensors (compass, magnetometer), barometers, WiFi sensors, RFID sensors, near-filed communication (NFC) devices, gyroscopes, pressure sensors, pressure gauges, time pressure gauges, torque sensors, ohmmeters, thermometers, infrared sensors, microphones, image sensors (e.g. digital cameras), biosensors (e.g. photometric biosensors, electrochemical biosensors), capacitance sensors, radio antennas, biometric sensors, capacitance probes and/or any combination thereof. It should be noted that the other sensor devices other than those listed can also be utilized to ‘sense’ context data.

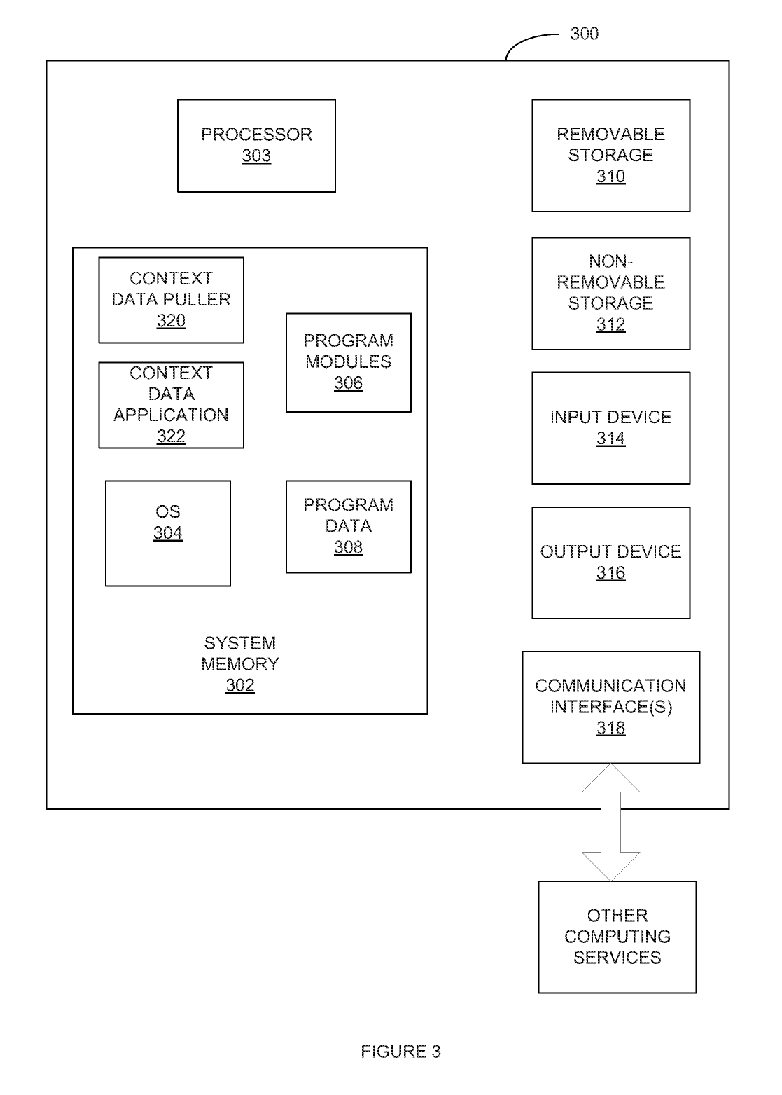

FIG. 3 shows a block diagram of a computer operable to execute the disclosed architecture of a communications server, according to some embodiments. In a basic configuration, the communication server 300 typically includes at least one processing unit 303 and system memory 302. Depending on the exact configuration and type of computing device, system memory 302 can be volatile (such as RAM), non-volatile (such as ROM, flash memory, etc.) or some combination of the two. The system memory 302 generally includes an operating system 304, one or more program modules 306, other program data 308, context-data puller 320 and context-data application 322. In some embodiments, system memory 302 can also include several of the functionalities of the mobile device 200 as program modules such as context-data application 322. Thus, communication server 300 can provide a resource to scale the processing power and battery resources of mobile device 200. Additionally, the communication server 300 can utilize a separate context-data store. In some embodiments, a separate context-data store can also be utilized to scale the data storage resources of mobile devices 102 and 104.

In some embodiments, the communication server 300 can include a context-data puller 320 and a context data application 322. Context-data puller 320 can acquire context data. For example, in some embodiments, context-data puller 320 can communicate a request to a mobile device and/or third-party system for context. Context-data puller 320 can store context data in a data store and generate a register of available context data. Context-data puller 320 can also retrieve historical context data from the data store. Context-data puller 320 can interact with a third-party system via an applied program interface (API), to acquire additional information about context data. For example, context-data puller 320 can acquire a map from a third-party mapping service hosted on third-party server 108.

In some embodiments, context-data puller 320 can acquire geolocation data. Geolocation can be performed by such methods as associating a geographic location with the Internet Protocol (IP) address, MAC address, RFID, hardware embedded article/production number, embedded software number (such as UUID, Exif/IPTC/XMP or modern steganography), invoice, Wi-Fi connection location, or device GPS coordinates, or even user-disclosed information. Context-data puller 320 can perform geolocation operations automatically on a periodic basis (e.g. maintain a substantially current geolocation of a particular user via multiple geolocation data vectors) and/or on a per-message basis. For example, context-data puller 320 can utilize a geolocation API client to look up an IP address on a WHOIS service and retrieve a registrant's physical address. In another example, context-data puller 320 can query the source of the message for GPS data.

Context-data application 322 can perform the same functions as context-data application 206 of FIG. 2 as adapted to the context of communication server 300. For example, context-data application 322 can analyze context data acquired by the context-data puller 204 to associate a relevant context data with a text message component according to the meaning of the text message component. For example, if the text message states “COME PARTY HERE WITH US”. Context-data application 322 can determine that the message component “HERE” meant the geolocation of the sending device. Context-data puller 320 can query the sending device for its GPS data with a time stamp that matches the time stamp of the text message. Context-data application 322 can then provide instructions for a website server to associate the text message component with the GPS data. In some embodiments, context-data application 322 can determine the geolocation data of the sending device from the data of the text message. In some embodiments, context-data application 322 can determine the meaning of the component “WITH US” as the set of social networking friends present at substantially the same location. Context-data puller 320 can, for example, then query the mobile devices of the sender's social networking friends to determine the location of each at the time indicated by the time stamp included in the text message. In some embodiments, the mobile device 102 can have identified certain mobile device in a physical proximity to it. A functionality of the mobile device 102 (e.g. context-data application 208) can have include this identity as context-meta data in the text message. Context-data application 322 can then determine the identity of the users of any mobile devices included in the data of the text message by the sending mobile device. User identity and/or other mobile device data can be stored in database 108. In some embodiments, context-data application 322 can then generate an instruction for a website server to link the user's identities with the message component “WITH US” on a webpage.

In some embodiments, context-data application 322 can be set to algorithmically associate a particular type of context data (e.g. geolocation data of a sending device) with a text message regardless of the meaning of the text message component. In some embodiments, the communication server 300 can provide instructions to mobile devices 102 and/or 104 to acquire and return certain context-data to the communication server 300. In such a case, context-data application 322 can maintain the substantially current context data in a database.

The context-data application 322 can include a search engine to search for information on the World Wide Web and/or another database that is relevant to the text message and/or context data. This information can be included in the text message as context-enhancement data. In some embodiments, context-data application 322 can also be functionally coupled with a database (such as an external database) that includes data such as historical text messages, historical context data and/or user/subscriber information. This data can be also be utilized as context-enhancement data in a text message. In some embodiments, context-data application 322 can also perform such operations as determine the quality of the context data (e.g. geolocation accuracy), quality of service of context data sources, and the like.

Communication server 300 can include additional features or functionalities. For example, the communication server 300 can also include additional data storage devices (removable and/or non-removable) such as, for example, magnetic disks, optical disks, or tape. Such additional storage is illustrated in FIG. 3 by removable storage 310 and non-removable storage 312. Example, computer storage media can include volatile and nonvolatile, removable and non-removable media implemented in any method or technology for storage of information, such as computer readable instructions, data structures, program modules, or other data. The system memory 302, removable storage 310 and non-removable storage 312 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, firmware, magnetic disk storage or other magnetic storage devices, or any other medium which storage media can be part of the communication server 300. These computer storage media can include computer-executable instructions for implementing the various embodiments described herein. The communication server 300 can also have input device(s) 314 such as a keyboard, a mouse, a pen, a voice input device, a gesture-based interface and/or a touch-sensitive input device. Output device(s) 316 such as a display, speakers, printer, etc. can also be included.

The communication server 300 can also include communication interfaces 318 that allow the device to communicate with other computing devices over a communication network. Communication interfaces 318 are one example of communication media. Communication media can be embodied by computer readable instructions, data structures, program modules, or other data in a modulated data signal, such as a carrier wave or other transport mechanism, and includes any information delivery media. The “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. The computer readable media as used herein can include both storage media and communication media according to various example embodiments.

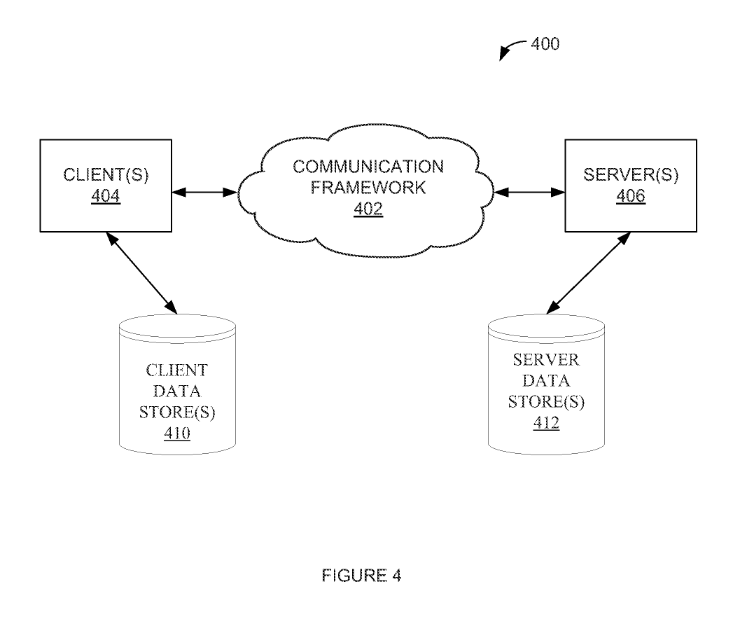

FIG. 4 illustrates a block diagram of an exemplary client-server computing environment 400 in accordance with the methods and operations described herein. The system 400 includes one or more client 404. The client 404 can be hardware circuitry and/or software applications (e.g., threads, processes, computing devices), that initiates communications with the server 406 according to the client-server communication paradigm. Client 404 can be implemented in a variety of ways, including as a computer, portable digital assistant (PDA), communication device, and the like. Clients 404 is equipped with conventional mechanisms to receive the communication framework 402, such as ports, network cards, receivers, modems, and so on. Client 404 can house cookie(s) and/or associated contextual information to perform the methods and operations of some embodiments.

System 400 also includes one or more servers 406. In some embodiments, server 406 can also be hardware circuitry and/or software applications (e.g., threads, processes, computing devices). Server 406 can house threads to perform the methods and operations described by herein. One possible communication between a client 404 and a server 406 can be in the form of a data packet adapted to be transmitted between two or more computer processes. The data packet can include a cookie and/or associated contextual information, for example. Server 406 can be implemented in a number of ways, such as a host server of a Website, a dedicated search engine (e.g., that stores information for searching but not the content for search hits), telecommunications server and so forth. The content can be organized and made available to client 406 in any of a wide variety of conventional manners. The information communicated from server 406 may be in any data type (e.g., text, graphics, audio, video, etc.) and contain essentially any type of subject matter.

System 400 includes a communication framework 402 (e.g., communications network 300, the Internet, etc) that can be employed to facilitate communications between the client 404 and the server 406. Communications can be facilitated via a wired (including optical fiber) and/or wireless technology. Client 404 can be communicatively connected to one or more client data stores 410 that can be employed to store information local to the client 404 (e.g., cookie(s) and/or associated contextual information). Similarly, the server 406 can be operatively connected to one or more server data stores 412 that can be employed to store information local to the server 406. It should be noted, that in some embodiments, a particular application can function as a client in one context or operation and as a server in another context or operation.

In some embodiments, system 400 can be modified to implement a client-server communication paradigm for several types of text message protocols. For example, in some embodiments, client 404 can be configured to create a context-enriched MMS message (e.g. with an MMSCOMP utility). The MMSCOMP utility can accept an input a file that includes text representations of an MMS header, and one or more files (image, sound, text, context data, etc.) to comprise the multipart message content. The MMS message can be formatted based, in part, upon an MMS Encapsulation Protocol Specification. Server 406 can then be a MMSC Messaging Server configured to store and deliver the context-enriched MMS message. Client 404 can interface with Server 406 through an MM7 interface.

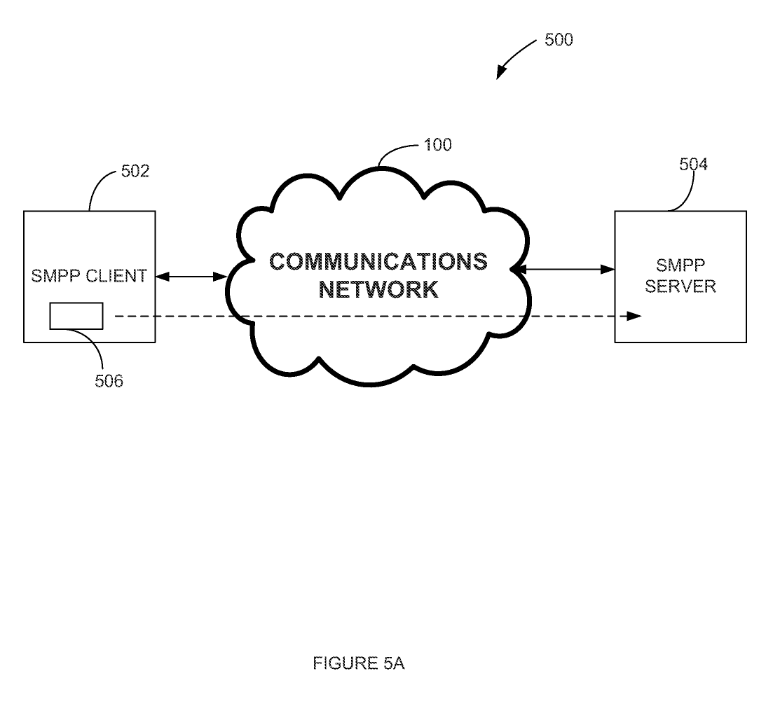

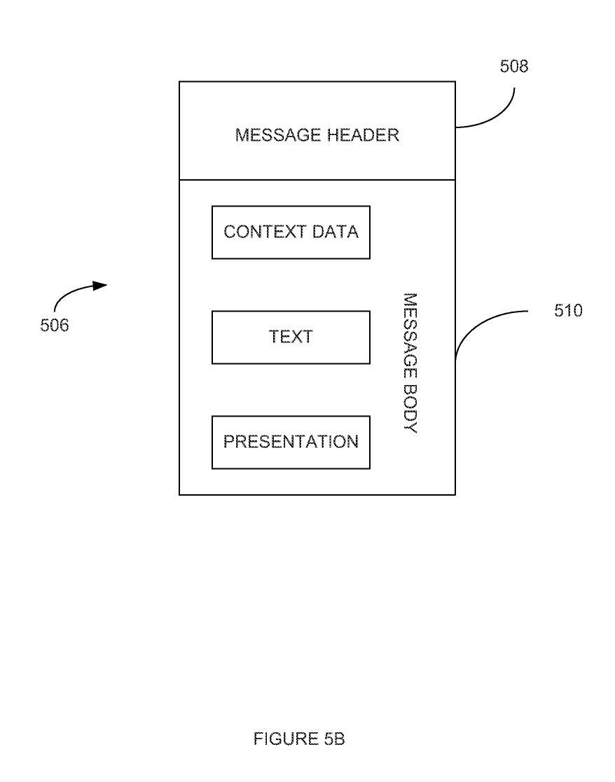

FIG. 5A illustrates an implementation of a client-server communication paradigm with an SMPP protocol, according to some embodiments. System 500 includes communications network 100, SMPP client 502 and SMPP server 504. SMPP client 502 can be an application residing on a mobile device and/or a server communicatively coupled with the communications network 100. SMPP client 502 can include an SMS gateway functionality. In some embodiments, a portion of the link between the SMPP client 502 and an SMPP server 504 can be a leased line and/or the Internet. The link can optionally include a virtual private network (VPN) or other means of securing the communication of data. SMPP server 504 can be an SMSC configured to store and deliver context-enriched messages such as context-enriched SMS messages and the like. It should be noted that in some embodiments, system 500 can be modified to implement other transport protocols than SMPP.

A context-enriched message 506, as shown in FIG. 5B, for example, can be communicated to the SMPP server 505. Message 506 can include message header 508 and message body 510. Message body 510 can include context data, text, and presentation instructions for a graphical user interface (GUI). In some embodiments, the contents of message 506 can be can be sent using multiple messages (e.g. concatenated SMS, multipart, segmented SMS and/or “Long SMS”) if message 506 is greater than the allowed size (e.g. 140 octets). In such a case, each message header 508 can include a user data header (UDH) that includes segmentation information.

In some embodiments, SMPP server 504 can store portions of message 506. SMPP server 504 can then include metadata providing retrieval instructions for a context-data application of a receiving mobile device to obtain the stored portions of message. In some embodiments, SMPP server 504 can forward portions of message 506 to another entity that can store message 506, such as another SMSC, MMSC, communications server 106 and the like. In such an example, SMPP server 504 can provide a message to the receiving mobile device that identifies the entity and a mechanism for retrieving portions of message 506. For example, the message can include a Uniform Resource Locator (URL) as text and/or a hyperlink to a webpage document that includes context data and/or context-enhancement data.

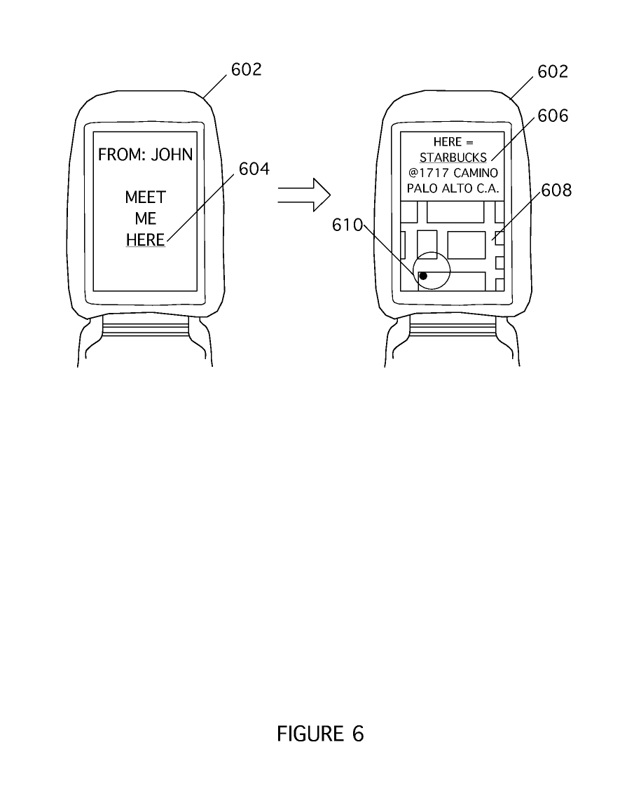

FIG. 6 illustrates an example context-enriched message presented on a display of a mobile device, according to some embodiments. A context-enriched message can have been generated by a context-data application of a sending mobile device (not shown). The term ‘here’ has been associated with a location of the sending mobile device at the time the text message was generated. In this particular example, the location was a Starbucks® cafe in Palo Alto, Calif. Receiving mobile device 602 can render the context-enriched message with a GUI. The term ‘here’ can include a hyperlink to a set of components that include context data and/or contest enhancement data. For example, the hyperlink can lead to a website hosted by a communications server. The website can comprise components 606, 608 and 610. Component 606 provides a description of the term ‘here’ in terms of the context of the sending mobile device. Component 608 includes a mashup of a map and a representation of the location—component 610. Component 610 is an icon representing the location of the sending mobile device at the time the context-enriched message was generated.

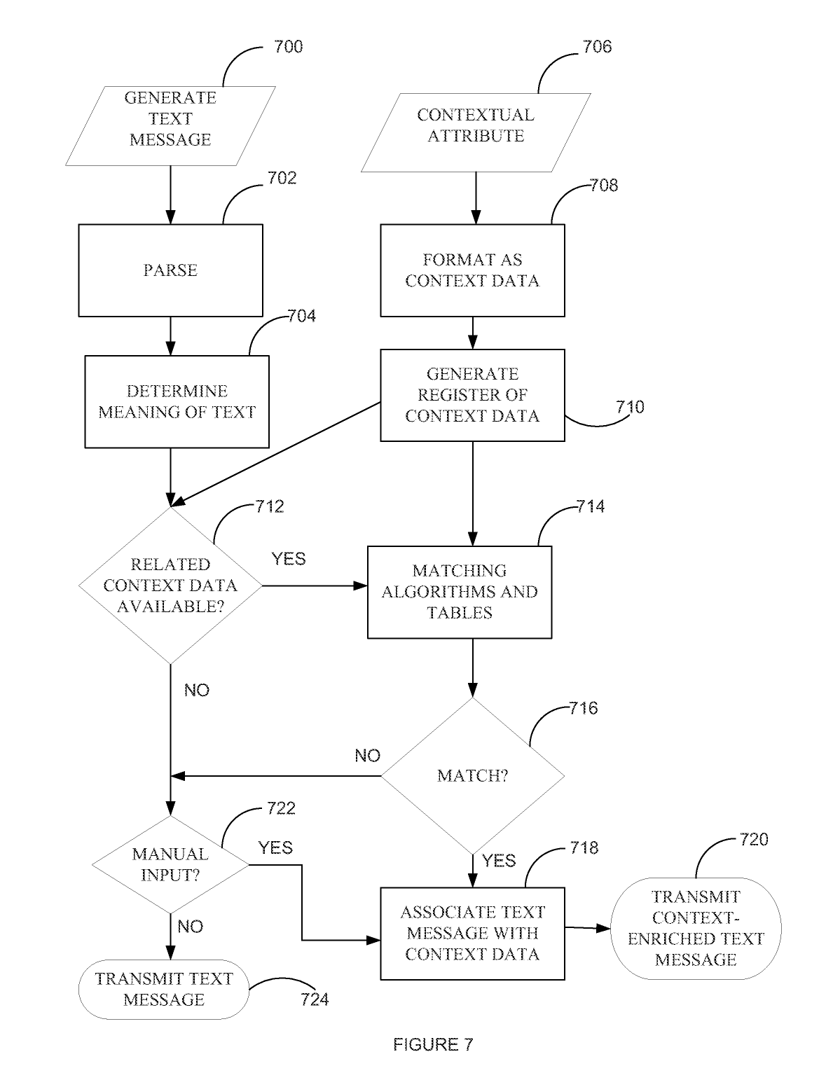

FIG. 7 is a flowchart illustrating the generation of a context-enriched message, according some embodiments. A text message can be generated (e.g. with a text-messaging application) 700. The text message can be provided to a context-data application. In some embodiments, the context-data application can be configured to operate in the mobile device and/or on an external server. The text message can be parsed 702. A text-message component can be analyzed to determine its meaning 704. A contextual attribute of the mobile device can also be acquired 706. For example, a sensor can sense the contextual attribute. The contextual attribute can be formatted as context data 708. The context data can be stored in a register 710. In some embodiments, the context data can be communicated to a server and stored in the server. In some embodiments, the register can be located within the local memory of the mobile device. The context-data application can determine if a context data is related to the text-message component 712. It should be noted, that in some embodiments, the context data may not be acquired until it the meaning of the text-message component is determined. Matching algorithms (e.g. textual analytics algorithms) and tables can be utilized to determine to match the context-data is related to the text-message component 714 and 716. If a match is determined, the context data is associated with the text-message component 718. A context-enriched text message is then transmitted 720. If no relevant context data is available, or no match is determined, the user is provided an opportunity to manually associate context data with the text message component 724. Otherwise, the text-message is transmitted without context data 724.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, firmware, software or any combination of hardware, firmware, or software embodied in a machine readable medium. For example, the various electrical structure and methods may be embodied using transistors, logic gates, application specific integrated (ASIC) circuitry or Digital Signal Processor (DSP) circuitry.

In addition, it will be appreciated that the various operations, processes, and methods disclosed herein may be embodied in a machine-readable medium or a machine accessible medium compatible with a data processing system, and may be performed in any order. Accordingly, the Specification and Drawings are to be regarded in an illustrative rather than a restrictive sense.

What is claimed is:

1. A method using the results of providing a text message generated by a mobile device;
identifying a message component of the text message; determining a contextual attribute of the mobile device; and, deriving a context data from the contextual attribute;
comprising:
generating a context-enriched message comprising the message component and the context data.

2. The method of claim 1 further comprising:
communicating the context-enriched message to an element of a cellular network.

3. The method of claim 1, wherein the contextual attribute of the mobile device comprises a geolocation of the mobile device.

4. The method of claim 1, wherein the text message is composed by a human user.

5. The method of claim 1, wherein the text message comprises a multimedia message service (MMS) message.

6. The method of claim 1, wherein the text message comprises a short message service (SMS) message.

7. The method of claim 1, wherein the mobile device comprises a smart phone.

8. A context-enriched text message prepared by a process comprising:
providing a text-message component generated with a mobile device;
providing a context data, wherein the context data comprises information about a contextual attribute of the mobile device;
associating the text-message component and the context data;
including the text-message component and the context data in a context-enriched text message.

9. The context-enriched text message prepared by the process of claim 8, wherein the context data is relevant to a meaning of the text-message component.

10. The context-enriched text message prepared by the process of claim 9 further comprising:
providing an instruction to a graphical user interface of a receiving mobile device to present the context data as a hyperlink embedded within the context-enriched text message.

11. The context-enriched text message prepared by the process of claim 9, wherein the hyperlink references a webpage with additional information about the context data.

12. A computer-implemented method comprising:
providing a short message from a first mobile device;
processing the short message through at least one server, said processing further comprising:
parsing the short message;
generating the short message's context data;
associating the context data with the short message; and,
encoding the short message and the context data into a format transmittable through a communication network.

13. The method of claim 12, wherein the communication network comprises a cellular network.

14. The method of claim 12, wherein the communication network comprises an IP network.

15. The method of claim 12, wherein the server comprises at least a cultural database comprising a database of prior short messages.

16. The method of claim 15, wherein the database of prior short messages comprises a token and a first word structure pattern.

17. The method of claim 16 further comprising:
comparing an indeterminate token in the short message against the token contained in the cultural database to find a best match.

18. The method of claim 17 further comprising:
comparing a second word structure pattern of the short message against the first word structure pattern contained in the cultural database to find the best match.

19. The method of claim 18 further comprising:
using the best match for the indeterminate token and second word structure pattern of the short message to establish a translation linkage between the short message and context data.

20. The method of claim 12, wherein a machine is caused to perform the method of claim 12 when a set of instructions in a form of a machine-readable medium is executed by the machine.
